(19) United States
(12) Patent Application Publication
(10) Pub. No.: US 2003/0223357 A1
(43) Pub. Date: Dec. 4, 2003

(54) Scalable path protection for meshed networks

(76) Inventor: Cheng-Yin Lee, Ottawa (CA)

Correspondence Address: MARKS & CLERK, P.O. BOX 957, STATION B, OTTAWA, ON, K1P 5S7, CA

(21) Appl. No.: 10/230,294

(22) Filed: Aug. 29, 2002

(30) Foreign Application Priority Data
May 31, 2002 (CA) 2,388,575

(51) Int. Cl. H04L 1/00

(52) U.S. Cl. 370/218

(57) ABSTRACT

A system and method for providing path protection for meshed networks is described. A backup tree having one or more backup paths interfaces with a destination node to provide path protection for one or more working paths. At least a portion of the backup paths share a common route on the backup tree. The common route extends from the destination node to the source nodes and ends at a merging point at which the backup paths diverge.

### FIELD OF THE INVENTION

This invention relates to networks such as meshed communications networks and more particularly to systems and methods of providing path protection in such networks.

### BACKGROUND

Networks, of the type contemplated by the present invention, typically consist of numerous processing sites also known as nodes which are joined together by an arrangement of physical or logical connections known as links. In a communications application of such networks, a source node communicates with a destination node to pass voice, data and video information there between. An end to end connection or path is established over links between the intermediate nodes. As is well known in the relevant art various algorithms are implemented to initiate and maintain a connection between the source and destination for the duration of the communication.

With the ever increasing demand for communication services, including but not limited to the Internet, the infrastructure needed to meet these demands has increased rapidly. The quality of service and delay tolerance for data communications vary but a considerable portion of this traffic requires high reliability. A common architecture for the delivery of communication services is a meshed network in which all nodes have a logical, direct connection to each other. A fully meshed network is one where all nodes have a direct connection to one another, but a meshed network may be partially meshed, e.g. A is connected to B and B is connected to C, but C is not connected to A. Meshed networks typically employ some type of self healing or path protection. With path protection, if a link or a node within a communication path goes out of service a fast and reliable way of re-routing a connection is provided.

Considerable prior art exists in path protection implementation and this prior art includes but is not limited to a solution described in a paper by Medard et al. entitled “Redundant Trees For Pre-Planned Recovery In Arbitrary Vertex-Redundant Or Edge-Redundant Graphs” published in networking, IEEE/ACM Transactions, Volume 7 Issue 5, October 1999. In the Medard et al. paper paths are protected in a network by arranging and connecting nodes such that they form two trees that allow any node to reach any other node in the network in the event of one fiber cut in the network.

A problem with this solution is that it may not always be possible to arrange the nodes in the described manner. Furthermore, whenever a new node is added both trees must be re-computed and the links connected according to the newly computed arrangement of the trees.

A second prior art solution is described in a paper by Grover et. al., entitled “Cycle-Oriented Distribute Pre-configuration: Ring-like Speed with Mesh-like Capacity for Self-planning Network Restoration” published in Proc. IEEE ICC 1998, June 1998, pp. 537-543. In this solution the authors describe P-cycles (i.e. pre-configured cycles) or “logical rings” to provide the backup paths required for path protection.

A problem with the second prior art solution is that at least the same number of backup paths as there are working paths (assuming only one working path is set up between any two nodes and hence no backup paths can be shared) is required. Additionally, using the “logical ring” in the backup direction may introduce delays that are not present in the working direction.

There also exists issued patents in the prior art including U.S. Pat. No. 6,337,846 to Bengston et al. which issued Jan. 8, 2002 entitled “Quantification of the quality of spare links in a telecommunications network”

This patent relates to a telecommunications network which is provisioned with a distributed restoration algorithm. In accordance with the algorithm spare links via which disrupted traffic may be re-routed are categorized into different quality levels based upon their respective anticipated near term availability and reliability. There are a number of categories ranging from dedicated high quality spare links along fully functional spans to low quality spare links that act as replacements for multiple working lengths in the same span as the failed working link. According to this prior art invention restoration links are shared i.e. they can provide protection to any one of several working links. The patent, however, doesn't disclose a branch and tree aspect of the shared protection tree as contemplated by the present invention.

Finally, U.S. Pat. 6,047,331 which issued Apr. 4, 2000 to Medard et al. and entitled “Method and Apparatus for Automatic Protection Switching” -is of interest. The Medard et al. patent (and paper referenced above) relates to network planning, i.e., how a physical network is configured such that any failed node or link/edge does not result in loss of connectivity between any source and destination node in the network. The Medard et al. network planning technique specifically involves generating first and second tree topologies for any source node in the network, which can be represented as a node or an edge redundant graph such that any node in the graph remains connected to the source node via at least one tree even after the failure of a node or an edge. This technique provides a recovery scheme upon detection of a failure in the network. This prior art patent also discloses the selection of a preferred pair of trees from a plurality of tree pairs on the basis of some cost criteria and further to generate balanced trees which have short paths. A limitation of the patented method to determine the tree topologies is that the network must be edge or node redundant therefore the invention is not applicable to all network topologies. Also, the physical network topology is based on the redundant tree topologies generated at the network planning stage. However, it may not be feasible to extend a physical network according to the generated topologies.

A further problem with the prior art solutions is their inability to scale well. Consequently, as the size of a meshed network grows, in terms of the number of nodes and working paths, the amount of bandwidth required for backup protection paths grows at the same rate (or higher) as that of the working paths. Also, although ring path protection is simple for a single ring, it does not scale well because there is a limit to the number of nodes that can be added to the ring network. Furthermore, interconnecting two rings with redundant paths also does not scale well because the paths interconnecting the rings require additional bandwidth as paths are added to the rings.

### SUMMARY OF INVENTION

The present invention is directed to the problem of efficiently providing path protection in a meshed network. The problem is particularly important to solve for large meshed networks because the number of possible working paths increases as the square of the number of nodes, and likewise would the number of backup paths for 1:1 or 1+1 path protection unless some efficiency can be realized.

The present invention provides carriers and Internet service providers with efficient path protection. Path protection is particularly important for large meshed networks that carry real time traffic. The present invention is important to services providers offering carrier grade voice over IP (VoIP) services because it enables path protection required by toll quality services to be provided in a cost effective manner.

Therefore in accordance with a first aspect of the present invention there is provided an arrangement of backup protection paths in a communications network, the arrangement comprising: a first backup tree, the backup tree comprising: a first backup path for protecting a first working path, the first backup path routed between a source node and a destination node of the first working path and being diversely routed thereto; a second backup path for protecting a second working path, the second backup path routed between another source node and the destination node of the second working path and being diversely routed thereto; and a portion in which the first and second backup paths share a common route, the common route extending from the node where the first and second backup paths merge to the source nodes and ending at a merging point at which the first and second backup paths diverge.

In accordance with a second aspect of the present invention there is provided a method of specifying a backup protection path for a working path having a link state database in a communications network comprising: creating a diverse route by pruning the link state database of the working path before selecting an associated backup path; and adding additional protection for new working paths by adding a branch from a source of the working path to a merge point on a backup tree for a destination node of the working path.

In accordance with a third aspect of the present invention there is provided a method of protecting a failed working path in a present communication network comprising: switching traffic from the failed working path immediately to an associated backup path providing a shared portion of a backup tree supporting the backup path has enough available bandwidth to support traffic from the failed working paths, otherwise, wait for an acknowledgement from a destination node in order to use the backup path in order to avoid contention.

### BRIEF DESCRIPTION OF THE DRAWINGS

The invention will now be described in greater detail with reference to the attached drawing wherein:

FIG. 1 is a high level diagram of a meshed network showing working paths and backup paths.

### DETAILED DESCRIPTION OF THE INVENTION

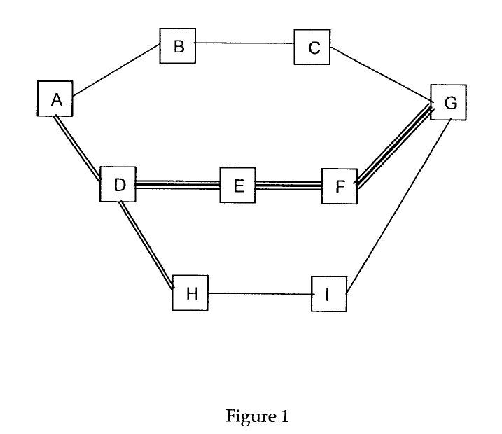

Referring to FIG. 1, according to the present solution a group of working paths, each path having a respective source node and a destination node common to the other paths in the group, share a backup tree rooted at that destination node. For example, the path A-B-C-G is one working path and the path H-I-G is another working path in a group sharing the backup tree A/H-D-E-F-G. The links A-D and H-D are branches, the portion D-E-F-G is the trunk, and the node D is a merge point of the backup tree. If a link in either of the working paths is severed, then traffic from the corresponding source node can be re-routed over the backup tree to the destination node G.

In general, within a network, M diverse shared backup trees may be used to protect N ingress traffic paths to a particular destination node. The amount of resources required for protecting paths to the destination node is reduced by using a shared backup tree in accordance with the invention, instead of using multiple point-to-point backup paths as in the prior art. For example referring to FIG. 1, to protect the working path H-I-G, only the link H-D needs to be added to the existing backup tree (A-D-E-F-G). The bandwidth resources within each backup tree may be shared among all sources to which the tree is assigned, or a portion of the bandwidth may be assigned to each source. For example a 10 Gbps backup path could protect ten 1 Gbps working paths.

The selection of the backup path for a given working path is chosen to be diverse from the routing of the working path. This is done by selecting the shortest path from source to destination based on the pruned link state database, i.e. the network database with the links of the working path removed. Similarly, additional working paths from another source to the destination can be selected by further pruning the backup path, or backup tree, from the link state database before selecting the additional working paths. After an additional working path has been selected in this manner, a branch can be added to the backup tree to provide a shared backup path for the new working path. The branch would be added to the backup tree at a merging point, which could be explicitly specified if desired to better control the formation of the backup tree.

Upon detection of a link failure in the working path the source node will switch transmission over to the backup path immediately, or optionally upon receiving an acknowledgement from the destination node to use the backup path. The latter approach is useful to avoid contention for the backup tree, in the case where the tree is shared among several working paths. Alternatively in the case of a link failure, the source node could bridge its transmission to the backup path and allow the destination node to select the better signal. Fast reroute may be used to restore the failed path and bridging the signals reduces the impact of switching back to the working path after the restoration.

Managing the backup trees and disseminating the backup path routes could either be done in a distributed manner, e.g. Private Network Node Interface (PNNI) signalling for ATM, or in a centralized manner with a Network Management System (NMS).

The invention requires only N backup trees to protect all N squared paths in a network with N nodes. This solution scales well as the number of nodes in a network grows since paths to a new node can be protected by grafting branches from other nodes to a new backup tree rooted at the new node. If there are X paths in a network, in general, at least X backup paths are required for a mesh-restorable network. According to the invention, since the bulk of the path can be shared, the additional backup resources required for each additional working path are much less than adding a point-to-point backup path, since only a much shorter path/branch to the backup tree needs to be added.

To minimize the time required to do a protection switch, backup paths can be set up in such a way that, the backup path is only merged at one point on the trunk/backbone of the tree. Otherwise, all merge points from the source to the destination have to be switched during protection switching (in response to a link failure).

To do this, the backup trunk for a destination is set up and advertised via an IGP-TE (Interior Gateway Protocol-Traffic Engineering) (e.g. OSPF-TE, IS-IS-TE or PNNI) A source should compute a (TE constrained) backup path towards one of the nodes on the trunk. This ensures that during protection switching, only one merge point on the trunk needs to be switched (or cross-connected to the branch where the source is located).

Although FIG. 1 shows a meshed network with single backup tree it will be apparent to one skilled in the art that a large scale network can have multiple backup trees each supporting one or more backup paths.

In summary, the solution provided by the present invention reduces the amount of network resources required for protecting paths in a meshed network. It also allows easy addition of backup paths to protect new working paths that are added as a network grows or changes.

The invention provides carriers/ISPs efficient path protection, which is particularly important for large meshed networks that carry real-time traffic. This invention is important to service providers offering carrier-grade VoIP services because it enables the path protection required by toll quality services to be provided in a cost-effective manner.

Although particular embodiments of the invention have been described and illustrated it will be apparent to one skilled in the art that numerous changes can be made without departing from the basic concept. It is to be understood, however, that, to the extent possible, such changes will fall within the full scope of the invention as defined by the appended claims.

1. An arrangement of backup protection paths in a communications network, the arrangement comprising:
a first backup tree, the backup tree comprising:
a first backup path for protecting a first working path, the first backup path routed between a source node and a destination node of the first working path and being diversely routed thereto;
a second backup path for protecting a second working path, the second backup path routed between another source node and the destination node of the second working path and being diversely routed thereto; and
a portion in which the first and second backup paths share a common route, the common route extending from the node where the first and second backup paths merge to the source nodes and ending at a merging point at which the first and second backup paths diverge.

2 The arrangement as defined in claim 1, the first backup tree further comprising a third backup path having a route that joins the first backup tree at another merging point

3 The arrangement as defined in claim 1 further comprising a second backup tree defined in a like manner as the first backup tree but for fourth and fifth backup paths.

4. The arrangement as defined in claim 2 further comprising a second backup tree defined in a like manner as the first backup tree but for fourth and fifth backup paths.

5. The arrangement as defined in claim 1 wherein the common route portion of the first backup tree has sufficient resources to carry traffic from both of the first and second working paths simultaneously.

6. The arrangement as defined in claim 2 wherein the common route portion of the first backup tree has sufficient resources to carry traffic from both of the first and second working paths simultaneously

7. A method of specifying a backup protection path for a working path having a link state database in a communications network comprising:
creating a diverse route by pruning the link state database of the working path before selecting an associated backup path; and
adding additional protection for new working paths by adding a branch from a source of the working path to a merge point on a backup tree for a destination node of the working path.

8. The method as defined in claim 7 where the merge point of a branch to the backup tree for a particular backup path is specified explicitly.

9. The method as defined in claim 8 wherein a selected backup path is communicated in a distributed manner.

10. The method as defined in claim 8 wherein a selected backup path is communicated in a centralized manner.

11. The method as defined in claim 8 wherein additional working paths are selected by first pruning the backup path from the link state database before the working path is selected.

12. The method as defined in claim 8 wherein the backup path is only merged at one point on the backup tree to optimize protection switching time.

13. A method of protecting a failed working path in a present communication network comprising:
switching traffic from the failed working path immediately to an associated backup path providing a shared portion of a backup tree supporting the backup path has enough available bandwidth to support traffic from all of its working paths, otherwise, wait for an acknowledgement from a destination node in order to use the backup path in order to avoid contention.

14. The method as defined in claim 13 wherein traffic is bridged to the backup path and said destination node selects its best signal.

15. The method as defined in claim 14 wherein the best signal is from the backup path in the event of failure on the working path.

16. The method as defined in claim 13 wherein details on how to implement bridging and switching over is provided for ATM technologies.

17. The method as defined in claim 13 wherein details on how to provide bridging and switching over is provided for MPLS technology.
